(19) United States
(12) Patent Application Publication
(10) Pub. No.: US 2012/0095668 A1
(43) Pub. Date: Apr. 19, 2012

(54) METHOD FOR FEED-FORWARD CONTROLLING FUEL INJECTION INTO A CYLINDER OF AN INTERNAL COMBUSTION ENGINE

(75) Inventors: Gerhard LANDSMANN, Roedern (DE); Alessandro CATANESE, Orbassano (IT)

(73) Assignee: GM GLOBAL TECHNOLOGY OPERATIONS LLC, Detroit, MI (US)

(21) Appl. No.: 13/275,406

(22) Filed: Oct. 18, 2011

(30) Foreign Application Priority Data
Oct. 18, 2010 (GB) 1017949.7

(51) Int. Cl. F02D 41/30

(52) U.S. Cl. 701/103

(57) ABSTRACT

A method is provided for feed-forward controlling fuel injection into a cylinder of an internal combustion engine that includes, but is not limited to setting a desired value of a combustion parameter indicative of a fuel combustion within the cylinder, determining a value of one or more engine operating parameters, using the desired value of the combustion parameter and the determined values of the engine operating parameters for determining a value of a parameter of a fuel injection into the cylinder, and commanding a fuel injector associated to the cylinder to perform a fuel injection having the determined value of the fuel injection parameter.

### CROSS-REFERENCE TO RELATED APPLICATION

This application claims priority to British Patent Application No. 1017949.7, filed Oct. 18, 2010, which is incorporated herein by reference in its entirety.

### TECHNICAL FIELD

The technical field relates to a method for feed-forward controlling fuel injection into a cylinder of an internal combustion engine, principally an internal combustion engine of a motor vehicle, such as for example a Diesel engine, a gasoline engine or a gas engine.

### BACKGROUND

Modern internal combustion engine generally comprise a plurality of cylinders, each of which is provided with a dedicated fuel injector for injecting fuel into the cylinder. The fuel can be injected in the cylinder by means of a single injection pulse per engine cycle, or by means of a plurality of injection pulses per engine cycle according to a multi-injection pattern, typically by means of at least a pilot injection pulse and a following main injection pulse.

The fuel injection is defined by several fuel injection parameters, such as for example the start of injection (SOI), the fuel injected quantity, the energizing time (ET) of the fuel injector for each injection pulses, the dwell time (DT) between two consecutive injection pulse, and the injection pressure.

It is known to control the fuel injection using an open-loop control procedure. This conventional open-loop control procedure generally provides for: determining a value of a plurality of engine operating parameters, under which the engine currently operates and which affect the fuel combustion in the cylinders, such as for example engine speed, engine load, engine temperature and many other parameters; determining the required value of one or more of the above mentioned fuel injection parameters, on the basis of the determined values of the engine operating parameters; and then commanding the fuel injector according to the required values of the fuel injection parameters. In particular, the required values of the fuel injection parameters are determined from predefined values stored in empirically determined maps, which correlates the engine operating parameters to the fuel injection parameters.

A drawback of this known procedure is the extremely high number of engine operating parameters affecting the combustion in the cylinders, which leads to a corresponding high number of maps, whose determination and calibration requires therefore long-lasting and highly complex experimental activities. This drawback is accentuated by the fact that most internal combustion engines are currently equipped with many auxiliary apparatuses, such as for example turbochargers, exhaust gas recirculation (EGR) systems and after treatment devices, whose operation affects the combustion and whose operating parameter are therefore to be taken into account for controlling the fuel injection, typically by means of additional empirically determined maps. Another drawback is that the above mentioned maps are conventionally calibrated under steady state conditions, so that the known open-loop control strategy is not always reliable for motor vehicle applications, where the internal combustion engine often operates under dynamic transient conditions in which the engine operating parameters can vary from engine cycle to engine cycle.

Generally the open-loop control procedure can also involve other side effects. For example, the operation of the fuel injectors in an internal combustion engine may change during time as a result of wear phenomena, thus the values of the fuel injection parameters provided by the maps can no longer supply the engine with the proper quantity of fuel at the right time. As a consequence, the performance of the engine can degrade, giving way to higher emissions, higher fuel consumption, increased noise and even the possibility of damage to the engine.

In order to improve such situation, more recent internal combustion engines, for example Diesel Premixed Charge Compression Ignition (PCCI) and gasoline Homogenous Charge Compression Ignition (HCCI), implements a closed-loop control procedure, which generally provides for: measuring a combustion parameter indicative of the combustion behavior; calculating an error between the measured value and an expected value of the same combustion parameter; and commanding the fuel injector in order to minimize this error. The controlled combustion parameter can be for example the Start-of-Combustion (SOC), the crank angle at which a fraction of 50% of the fuel injected mass has burnt (MFB50), the location of a peak pressure (LPP), the indicated mean effective pressure (IMEP) or another parameter.

Although such procedures exhibit acceptable performance, they are otherwise prone to defects typical of closed loop control. In particular, the combustion parameter can be measured only after the combustion happens, so that the closed-loop control procedure can adjust the operation of the fuel injector only for the next engine cycle, when the engine operating conditions can be completely changed.

As a consequence, the response of the closed-loop control procedure is generally not fast enough when the internal combustion engine operates under dynamic transient conditions, as usually happens in motor vehicle applications. These drawbacks cannot be solved by tuning the controller to react faster on transient condition, since it can results in instability and/or oscillations of engine combustion.

In view of the above, it is at least one object to provide a control strategy of the internal combustion engine, which allows to solve, or at least to positively reduce, the above mentioned drawbacks. In addition, other objects, desirable features and characteristics will become apparent from the subsequent summary and detailed description, and the appended claims, taken in conjunction with the accompanying drawings and this background.

### SUMMARY

An embodiment provides a method for feed-forward controlling fuel injection into a cylinder of an internal combustion engine comprising the steps of: setting a desired value of a combustion parameter indicative of a fuel combustion within the cylinder, determining a value of one or more engine operating parameters, using the desired value of the combustion parameter and the determined values of the engine operating parameters for determining a value of a parameter of a fuel injection into the cylinder, commanding a fuel injector associated to the cylinder to perform a fuel injection having the determined a value of the fuel injection parameter.

Since any changes of the engine operating parameters is taken into account before the combustion happens, this feed-forward control strategy has a fast response, which allows meeting the desired value of the combustion parameter also under transient operating condition, thereby increasing the engine performance and reducing the polluting emissions. This feed-forward control strategy has also a great robustness that avoids instability and/or oscillation of the fuel combustion within the cylinders.

According to an embodiment, the combustion parameter is chosen in the following group: indicated mean effective pressure, combustion duration, accumulated heat release, heat release rate, delta pressure over crank angle, and parameters describing combustion phasing. This parameters describing combustion phasing can be chosen in the following group: start of combustion, location of peak pressure, crank angle at which a given fraction of the injected fuel mass is burnt. This embodiment has the advantage that the above mentioned parameters provide a reliable indication about the combustion development in the cylinder.

According to another embodiment, the fuel injection parameter is chosen in the following group: start of injection, fuel injected quantity, duration of injection, energizing time of the fuel injector, injection pressure, and electric and hydraulic dwell time. These parameters have the advantage that they can be simply adjusted acting on the conventional electric signal used for commanding the fuel injector.

According to still another embodiment, the engine operating parameters are chosen in the following group: engine speed, engine load, engine temperature, exhaust gas recirculation rate, intake oxygen concentration, exhaust oxygen concentration, charge air pressure, charge air temperature, intake valve timing, exhaust valve timing, intake valve lift, exhaust valve lift, position of flaps for generating a charge air motion within the cylinder, and other fuel injection parameters. These parameters are usually used also for performing many other engine operating strategies, so that the determination of their values generally does not require additional sensors or additional computational effort.

According to an embodiment, the value of the fuel injection parameter is determined by means of a combustion model which receives as input the desired value of the combustion parameter and the determined values of the engine operating parameters, and which gives as output the value of the fuel injection parameter. This solution has the advantage that the model can be properly calibrated during a dedicated experimental activity, and then used for controlling all the internal combustion engines of a same kind.

According to an embodiment, the method comprises the further steps of: using the determined value of the fuel injection parameter and the determined values of the engine operating parameters for estimating a value of the combustion parameter, measuring a value of the combustion parameter, calculating a difference between the measured value and the estimated value of the combustion parameter, using the difference for correcting the combustion model. With this solution it is advantageously possible to periodically update the combustion model, so as to compensate eventual variation in the fuel injector operation, due for example to production spread, aging or other causes.

Another embodiment provides that the estimated value of the combustion parameter is determined by means of an additional combustion model which receives as input the determined value of the fuel injection parameter and the determined values of the engine operating parameters, and which gives as output the estimated value of the combustion parameter. This aspect has the advantage that also this additional model can be properly calibrated during a dedicated experimental activity, and then used for controlling all the internal combustion engine of the same kind.

According to still another embodiment, the above mentioned difference between the measured value and the estimated value of the combustion parameter is used for correcting also the additional combustion model. In this way, also the additional combustion model can be periodically updated, in order to take into account eventual variation in the fuel injector operation, due for example to production spread, aging or other causes.

According to another embodiment of the invention, the method comprises the further steps of: using the determined value of the fuel injection parameter and the determined values of the engine operating parameters for estimating a value of the combustion parameter, using the estimated value of the combustion parameter for predicting an undesired combustion mode, performing a preventing procedure, if this undesired combustion mode is predicted This embodiment has the advantage of giving a prediction of the combustion behavior under the determined values of the engine operation parameters, before this combustion happens, and therefore of allowing to prevent undesired combustion mode (e.g. misfire), by performing a proper corrective procedure.

The estimated value of the combustion parameter can be advantageously determined by means of the same combustion model mentioned above, which receives as input the determined value of the operating parameter of the fuel injector and the determined values of the engine operating parameters, and which gives as output the estimated value of the combustion parameter.

Another embodiment provides a method for operating an internal combustion engine equipped with a plurality of cylinders, wherein the feed-forward control method described above is performed for each cylinder individually. In this way, it is advantageously possible to determine a different value of the fuel injection parameter for each individual cylinder, taking into account the development of the combustion in that specific cylinder, for example by determining and/or updating dedicated combustion models, and thus achieving a better control of the engine operation.

The methods can be carried out with the help of a computer program comprising a program-code for carrying out all the steps of the methods described above, and in the form of a computer program product comprising the computer program. The computer program product can be embodied as an internal combustion engine provided with an ECU, a data carrier associated to the ECU, and the computer program stored in the data carrier, so that, when the ECU executes the computer program, all the steps of the method described above are carried out.

The method can be also embodied as an electromagnetic signal, said signal being modulated to carry a sequence of data bits which represent a computer program to carry out all steps of the method.

### BRIEF DESCRIPTION OF THE DRAWINGS

The present invention will hereinafter be described in conjunction with the following drawing figures, wherein like numerals denote like elements, and:

FIG. 1 schematically illustrates a turbocharged Diesel engine;

FIG. 2 is a control scheme which illustrates a method for controlling the engine according to an embodiment;

FIG. 3 is the control scheme of FIG. 2 according to an explanatory example; and

FIG. 4 is the control scheme of FIG. 2 according to another explanatory example.

### DETAILED DESCRIPTION

The following detailed description is merely exemplary in nature and is not intended to limit application and uses. Furthermore, there is no intention to be bound by any theory presented in the preceding background or summary or the following detailed description.

An embodiment is hereinafter disclosed with reference to an internal combustion engine 1 of a motor vehicle, in this case a turbocharged Diesel engine, but it can be advantageously applied also to other kind of internal combustion engines, such as for example gasoline engine and gas engine. The internal combustion engine 1 comprises four cylinders 10, each of which communicates with an intake manifold 20 through at least an intake valve, and with an exhaust manifold 30 through at least an exhaust valve. Each cylinder 10 is further provided with a dedicated fuel injector 40 for injecting fuel into the cylinder 10.

The engine 1 is further provided with: an intake line 21 for feeding fresh air from the environment in the intake manifold 20; an exhaust line 31 for discharging the exhaust gas from the exhaust manifold 30 into the environment; and a turbocharger 50 which comprises a compressor 51 located in the intake line 21, for compressing the air stream flowing therein, and a turbine 52 located in the exhaust line 31, for driving said compressor 51.

An intercooler 60, also referred as Charge Air Cooler (CAC), is located in the intake line 21 downstream the compressor 51 of the turbocharger 50, for cooling the air stream before it reaches the intake manifold 20. A diesel oxidation catalyst (DOC) 32 is located in the exhaust line 31 downstream the turbine 52 of the turbocharger 50, for degrading residual hydrocarbons (HC) and carbon oxides (CO) contained in the exhaust gas.

In order to reduce polluting emissions, the engine 1 is further provided with an exhaust gas recirculation (EGR) system, for routing back and feeding exhaust gas into the engine cylinders 10. The EGR System comprises an EGR conduit 70 fluidly connecting the exhaust manifold 30 with the intake manifold 20, an EGR cooler 71 located in the EGR conduit 70, for cooling the exhaust gas, and an electrically controlled valve 72 located in the EGR conduit 70 downstream of the EGR cooler 71, for regulating the flow rate of exhaust gas towards the intake manifold 20.

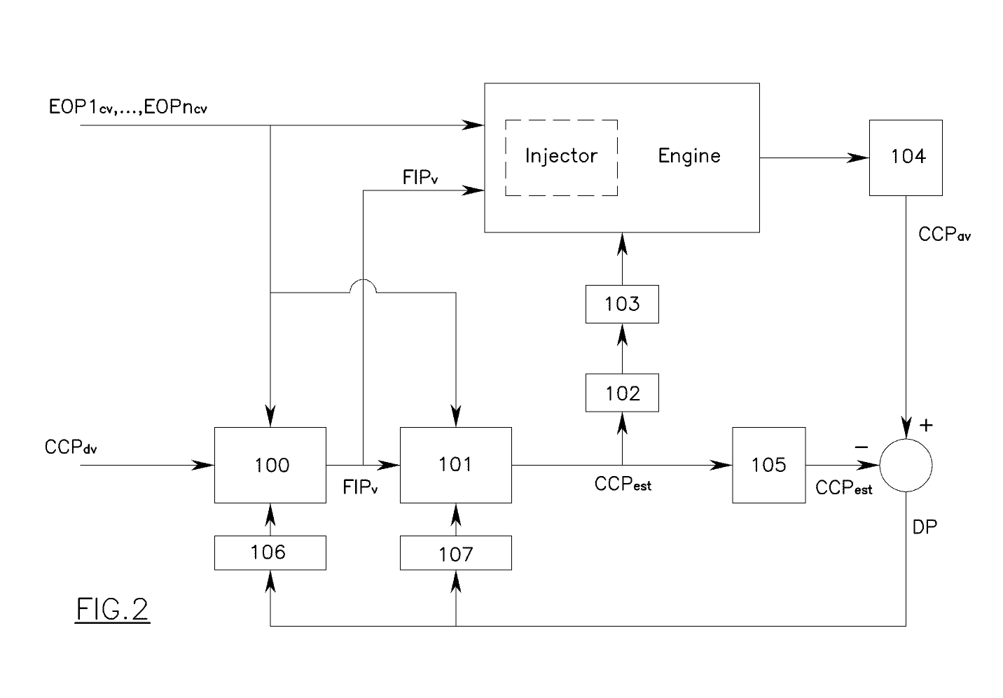

An embodiment provides a method for feed-forward controlling fuel injection into a cylinder 10 of the engine 1. This feed-forward controlling method provides for repeating, once per engine cycle, the steps schematically illustrated in the control scheme of FIG. 2. The control scheme comprises the initial step of setting a desired value CCP_{dv} of a parameter indicative of a fuel combustion within a single cylinder 10 of the engine 1, hereinafter referred as controlled combustion parameter.

This controlled combustion parameter can be chosen in the following group of combustion parameters: indicated mean effective pressure (IMEP), combustion duration, accumulated heat release, heat release rate, delta pressure over crank angle, and parameters describing combustion phasing, such as for example: start of combustion (SOC), location of peak pressure (LPP), crank angle at which a given fraction of the injected fuel mass is burnt, usually the crank angle at which the mass fraction burnt is the 50% of the total injected fuel mass (MFB50).

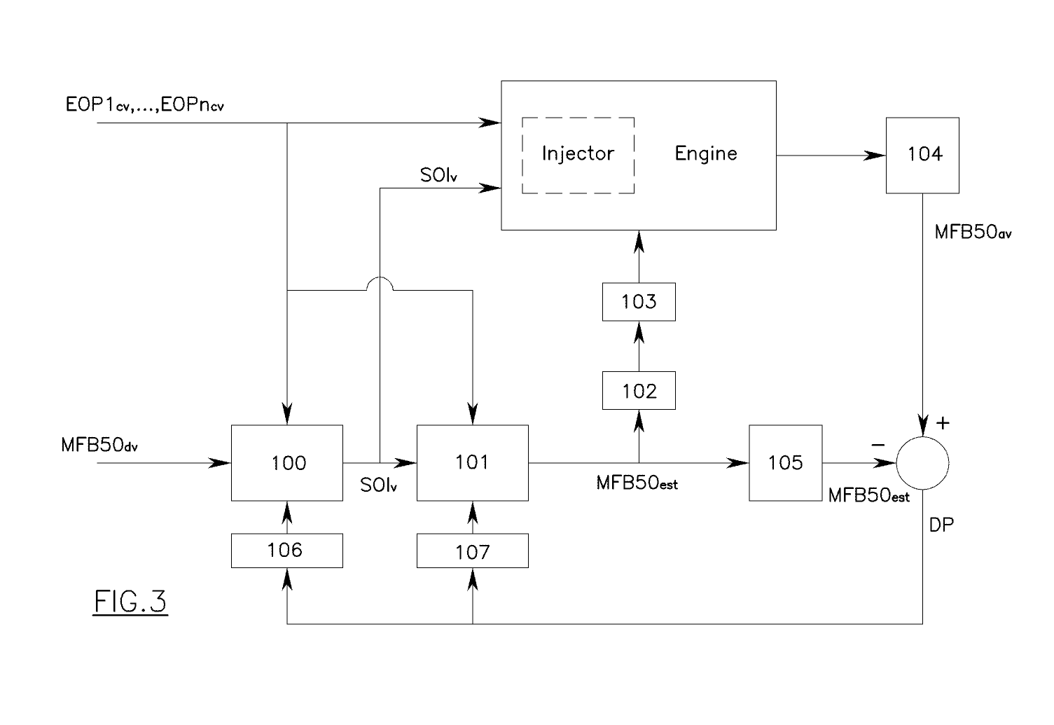

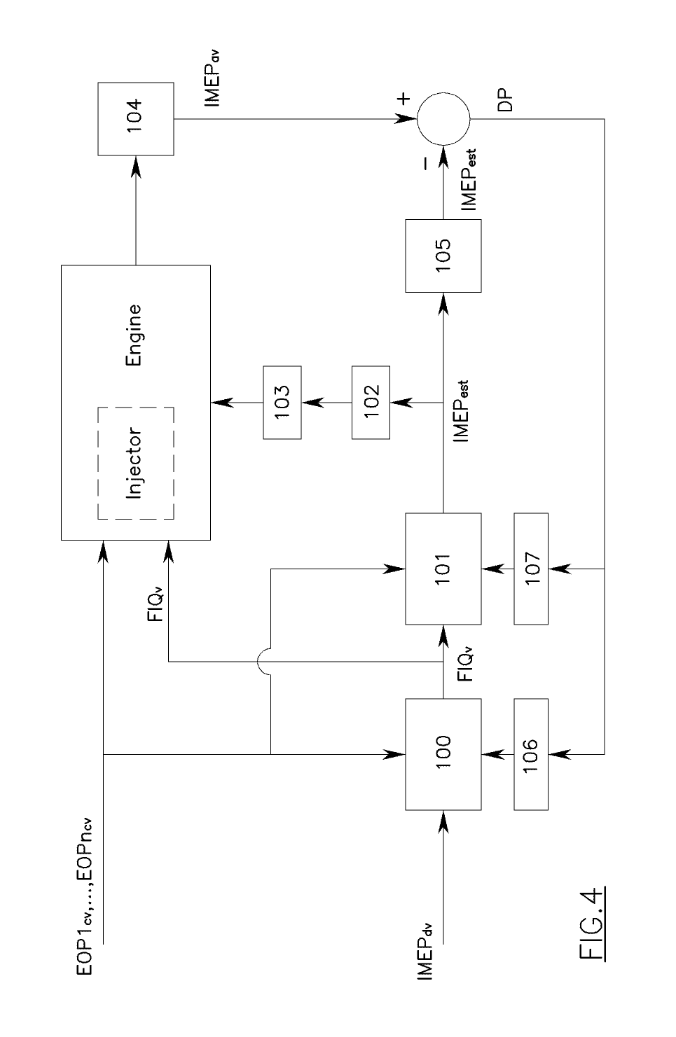

In the explanatory embodiment illustrated in FIG. 3, the combustion parameter is the MFB50 and its desired value is coherently indicated as MFB50_{dv}. In the explanatory embodiment of FIG. 4, the combustion parameter is the IMEP and its desired value is coherently indicated as IMEP_{dv}. The control scheme further comprises the step of determining a current value EOP1_{cv}, . . . , EOPn_{cv} of a plurality of engine operating parameters that affect the fuel combustion within the cylinder 10.

The determined current values EOP1_{cv}, . . . , EOPn_{cv} of the engine operating parameters and the desired value CCP_{dv} of the controlled combustion parameter are used as input in an inverse combustion model 100, which returns as output a value FIPᵥ of a parameter of a fuel injection in the cylinder 10, hereinafter referred as key fuel injection parameter.

In greater detail, the value FIPᵥ provided as output by the inverse combustion model 100 represents the value of the key fuel injection parameter that, under the current values EOP1_{cv}, . . . , EOPn_{cv} of the engine operating parameters, is expected to cause in the cylinder 10 a fuel combustion having the desired value CCP_{dv} of the controlled combustion parameter.

The key fuel injection parameter can be chosen in the following group of fuel injection parameters: start of injection (SOI) of an injection pulse, fuel injected quantity, duration of an injection pulse, energizing time (ET) of the fuel injector 40, injection pressure, electric and hydraulic dwell time (DT) between two consecutive injection pulses. In the explanatory embodiment illustrated in FIG. 3, the key fuel injection parameter is the SOI and its desired value is coherently indicated as SOIᵥ. In the explanatory embodiment of FIG. 4, the adjustable fuel injection parameter is the fuel injected quantity and its desired value is coherently indicated as FIQᵥ.

The above named engine operating parameters can be chosen in the following group: engine speed, engine load, engine temperature (e.g. engine coolant temperature, engine oil temperature and engine metal temperature), exhaust gas recirculation rate, intake oxygen concentration, exhaust oxygen concentration, charge air pressure, charge air temperature, intake valve timing, exhaust valve timing, intake valve lift, exhaust valve lift, position of flaps for generating a charge air motion within the cylinder (e.g. swirl and tumble flaps), and fuel injection parameters other than the key one.

The value FIPᵥ of the key fuel injection parameter provided by the inverse combustion model 100 is then used for commanding the fuel injector 40 associated to the cylinder 10. As a matter of fact, the fuel injector 40 is commanded so as to perform a fuel injection in which the actual value of the key fuel injection parameter is the determined value FIPᵥ.

The fuel combustion within the cylinder 10 occurs spontaneously after the fuel injection has started. The value FIPᵥ of the fuel injection parameter provided by the inverse combustion model 100 and the same current values EOP1_{cv}, . . . , EOPn_{cv} of the engine operating parameters are also used as input in a direct combustion model 101, which inversely returns as output an estimated value CCPₑₛₜ of the same controlled combustion parameter used as input of the inverse combustion model 100.

In greater detail, the estimated value CCPₑₛₜ provided as output by the direct combustion model 101 represents the value of the controlled combustion parameter that is expected to be measured during a fuel combustion that happens under the current values EOP1_{cv}, . . . , EOPn_{cv} of the engine operating parameters and the determined value FIPᵥ of the key fuel injection parameter. The estimated value CCPₑₛₜ can theoretically coincide to the desired value CCP_{dv} if the engine 1 operates for long time in a steady state condition, but generally they do not coincide. In the explanatory examples of FIGS. 3 and 4, the direct combustion model 101 returns an estimated value MFB50ₑₛₜ of the MFB50 and an estimated value IMEPₑₛₜ of the IMEP respectively.

According to the scheme of FIG. 2, the estimated value CCPₑₛₜ of the control combustion parameter is used in a routine 102 for predicting whether an undesired combustion mode (e.g., a misfiring) is to be expected or not, under the current values EOP1_{cv}, . . . , EOPn_{cv} of the engine operating parameters and the determined value FIPᵥ of the key fuel injection parameter.

The prediction of an undesired combustion mode can be performed in many known ways, such as for example by setting a threshold value of the controlled combustion parameter, and then predicting the undesired combustion mode if the estimated value CCPₑₛₜ of the control combustion parameter exceeds this threshold value. This prediction is performed before commanding the fuel injector 40 and therefore before the fuel combustion starts. As a consequence, if the prediction returns that no undesired combustion mode is expected, the fuel injector 40 is commanded as described above. Otherwise, if the prediction returns that an undesired combustion mode is expected, the scheme provides for performing a corrective procedure 103.

This corrective procedure 103 is performed before the fuel combustion starts and it is generally provided for avoiding the undesired combustion mode to occur. By way of example, the corrective procedure can provide for correcting the value FIPᵥ of the key fuel injection parameter, but it can also provide for modifying the value of other engine operating parameters which affect the fuel combustion, such as exhaust gas recirculation rate, charge air pressure, intake valve timing, exhaust valve timing, intake valve lift, and many other parameters.

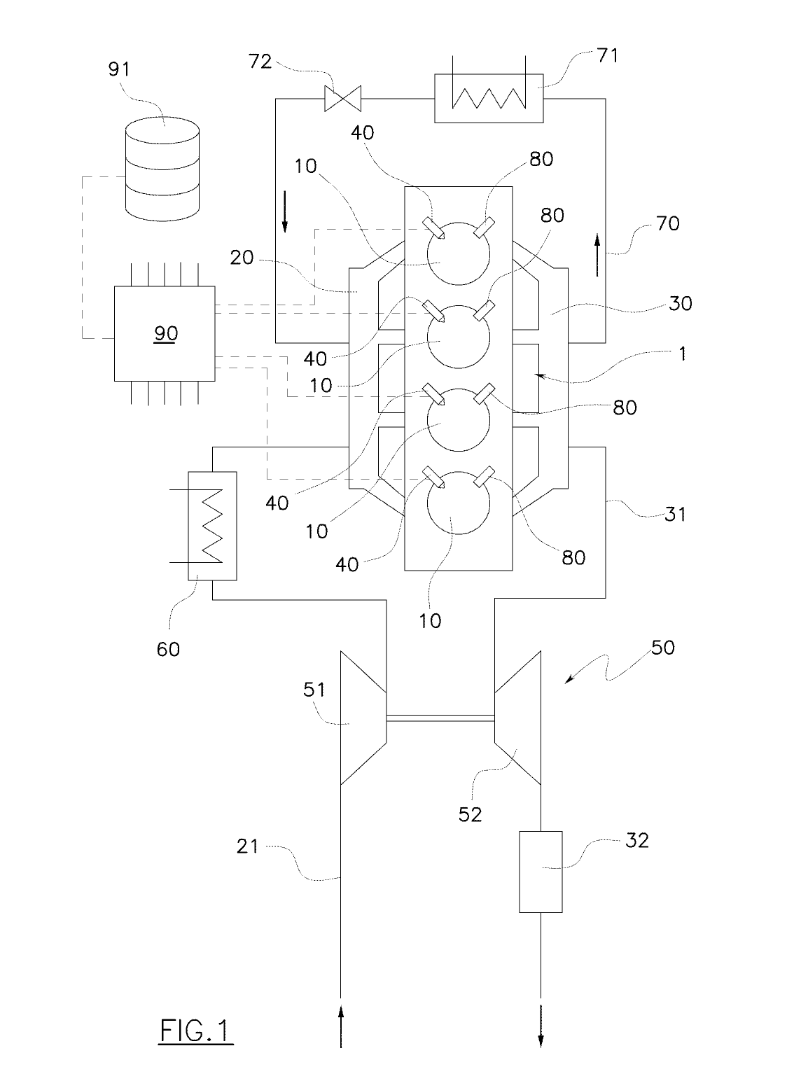

Once the fuel combustion has started, the control scheme comprises the step of measuring an actual value CCPₐᵥ of the controlled combustion parameter. The actual value CCPₐᵥ of the controlled combustion parameter can be measured by means of a pressure sensor 80 set inside the cylinder 10 (see FIG. 1), typically integrated in the glow plug associated to the cylinder 10 itself, and by means of known calculating procedure 104 which returns the value CCPₐᵥ of the controlled combustion parameter as a function of the in-cylinder pressure.

In the explanatory examples of FIGS. 3 and 4, the control scheme provides for measuring an actual value MFB50ₐᵥ of the MFB50 and an actual value IMEPₐᵥ of the IMEP respectively.

Afterwards, the control scheme comprises the step of calculating the difference DP between the measured value CCPₐᵥ and the estimated value CCPₑₛₜ of the controlled combustion parameter. Since the estimated value is determined before the fuel combustion really happens, it is previously delayed by means of a known synchro delay process 105, so as to wait for the sensor-based calculation of the actual value.

The difference DT is then used in an adaptation procedure 106 that eventually corrects the inverse combustion model 100 on the basis of said difference DT, and in another similar adaptation procedure 107 that eventually corrects the direct combustion model 101 on the basis of the same difference DT.

The above named direct combustion model 101 can be defined by linear/non-linear equations, linear/non-linear polynomial regression equations, artificial neural networks, maps, data sets or a mix of the above, which represents the physical relationships between the engine operating parameters, the key fuel injection parameter and the controlled combustion parameter. Combustion model of this kind are currently known to the persons skilled in the art.

The inverse combustion model 100 represents substantially the inverse relationships of the direct combustion model 101, and it can likewise be defined by linear/non-linear equations, linear/non-linear polynomial regression equations, artificial neural networks, maps, data sets or a mix of the above. In particular, the inverse combustion model 100 can be determined from the direct combustion model 101, for example by means of a known neural network training procedure.

The disclosed method for feed-forward controlling the engine 1 can provide for contemporaneously performing two or more of the control scheme described above, each of which involves a different controlled combustion parameter and a different key fuel injection parameter. By way of example, the method can provide for contemporaneously performing the control scheme illustrated in FIG. 3 and FIG. 4. Moreover, the disclosed method can be performed for all the engine cylinders 10 individually.

According to an embodiment, the controlling method can be performed with the help of a computer program comprising a program-code for carrying out all the steps of the method. This computer program is stored in a data carrier 91 associated to an engine control unit (ECU) 90 of the engine 1. In this way, when the ECU 90 executes the computer program, all the steps of the method described above are carried out.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the forgoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and in their legal equivalents.

What is claimed is:

1. A method for feed-forward controlling fuel injection into a cylinder of an internal combustion engine, comprising:
setting a desired value of a combustion parameter indicative of a fuel combustion within the cylinder;
determining a value of one or more engine operating parameters,
using the desired value of the combustion parameter and the value of the one or more engine operating parameters to determine a value of a parameter of a fuel injection into the cylinder; and
commanding a fuel injector associated to the cylinder to perform the fuel injection having the value of the parameter of the fuel injection into the cylinder.

2. The method according to claim 1, wherein the combustion parameter is indicated mean effective pressure

3. The method according to claim 1, wherein the combustion parameter is a parameter describing combustion phasing.

4. The method according to claim 3, wherein the parameter describing combustion phasing is a start of combustion.

5. The method according to claim 3, wherein the parameter describing combustion phasing is location of peak pressure.

6. The method according to claim 1, wherein the value of the parameter of the fuel injection into the cylinder is start of injection.

7. The method according to claim 1, wherein the value of the parameter of the fuel injection into the cylinder is electric and hydraulic dwell time.

8. The method according to claim 1, wherein the one or more engine operating parameters are engine speed.

9. The method according to claim 1, wherein the one or more engine operating parameters are fuel injection parameters.

10. The method according to claim 1, further comprising:
receiving by a combustion model the desired value of the combustion parameter and the value of the one or more engine operating parameters, which produces the value of the parameter of the fuel injection as an output; and
determining the value of the parameter of the fuel injection with the combustion model.

11. The method according to claim 10, comprising:
estimating a value of the combustion parameter with the value of the parameter of the fuel injection and the value of the one or more engine operating parameters;
measuring a measured value of the combustion parameter;
calculating a difference between the measured value and the value of the combustion parameter; and
using the difference for correcting the combustion model.

12. The method according to claim 1, comprising:
estimating a value of the combustion parameter with the value of the parameter of the fuel injection and the value of the one or more engine operating parameters;
predicting an undesired combustion mode with the value of the combustion parameter for; and
performing a preventing procedure if predicting the undesired combustion mode.

13. The method according to claim 12, wherein the value of the combustion parameter is determined with an additional combustion model that receives as input the value of the parameter of the fuel injection and the value of the one or more engine operating parameters, and which gives as output the value of the combustion parameter.

14. The method according to claim 11, further comprising using the difference between the measured value and the value of the combustion parameter for correcting an additional combustion model.

15. An internal combustion engine , comprising:
a cylinder;
an engine control unit configured to feed-forward control a fuel injection into the cylinder, the engine control unit configured to:
setting a desired value of a combustion parameter indicative of a fuel combustion within the cylinder;
determining a value of one or more engine operating parameters,
using the desired value of the combustion parameter and the value of the one or more engine operating parameters to determine a value of a parameter of the fuel injection into the cylinder; and
commanding a fuel injector associated to the cylinder to perform the fuel injection having the value of the parameter of the fuel injection into the cylinder.

16. A computer readable medium embodying a computer program product, said computer program product comprising:
a control program for feed-forward controlling fuel injection into a cylinder of an internal combustion engine, the control program configured to:
setting a desired value of a combustion parameter indicative of a fuel combustion within the cylinder;
determining a value of one or more engine operating parameters,
using the desired value of the combustion parameter and the value of the one or more engine operating parameters to determine a value of a parameter of a fuel injection into the cylinder; and
commanding a fuel injector associated to the cylinder to perform a fuel injection having the value of the parameter of the fuel injection into the cylinder.

17. The computer readable medium embodying the computer program product according to claim 16, wherein the combustion parameter is indicated mean effective pressure

18. The computer readable medium embodying the computer program product according to claim 16, wherein the combustion parameter is a parameter describing combustion phasing.

19. The computer readable medium embodying the computer program product according to claim 18, wherein the parameter describing combustion phasing is a start of combustion.

20. The computer readable medium embodying the computer program product according to claim 18, wherein the parameter describing combustion phasing is location of peak pressure.
